(19) United States
(12) Patent Application Publication
(10) Pub. No.: US 2016/0042306 A1
(43) Pub. Date: Feb. 11, 2016

(54) CARE PLAN REGIMENT DEVELOPMENT

(71) Applicant: Hunhu Healthcare Inc., Eden Prairie, MN (US)

(72) Inventors: Michael Gene Emerson, Eden Prairie, MN (US); Richard Dean Dettinger, Eden Prairie, MN (US)

(21) Appl. No.: 14/812,906

(22) Filed: Jul. 29, 2015

Related U.S. Application Data
(60) Provisional application No. 62/034,603, filed on Aug. 7, 2014.

(51) Int. Cl. G06Q 10/06

(52) U.S. Cl. CPC G06Q 10/06311; G06Q 50/22

(57) ABSTRACT

Embodiments of the invention include a system for helping a patient adhere to a care plan, the care plan designed to be followed by the patient in order to improve the patient's health, the system comprising: a task scheduling module configured to schedule one or more tasks included in the care plan, wherein a scheduled task is intended to be completed by the patient at the scheduled time; a task adherence estimation module configured to estimate the likelihood that the scheduled task will be completed by the patient at the scheduled time; and an alternative task presentation module configured to present the patient an alternative task, wherein the alternative task is intended to replace the scheduled task when the task adherence estimation module determines the patient is unlikely to complete the scheduled task and when the alternative task is accepted by the patient. Other embodiments are also included herein.

This application claims the benefit of U.S. Provisional Application No. 62/034,603, filed Aug. 7, 2014, the contents of which are herein incorporated by reference.

### FIELD OF THE INVENTION

The present invention relates to systems or methods for helping and aiding a patient adhere to a care plan. More specifically, the present invention relates to systems and methods that include adapting a care plan for a patient.

### BACKGROUND OF THE INVENTION

Patients are often assigned or prescribed a care plan from a healthcare professional, such as his/her doctor. A care plan can be designed to help a patient recover from a medical procedure, such as a surgery, or to improve the patient's health, such as to help the patient lose weight.

Patient refusal or inattention to following their care plans is an enormous problem for the health care system. A landmark study by the New England Journal of Medicine documented that $290 billion are wasted each year due to lack of patient engagement in their care plan activities.

While the causes of this waste are myriad, the most apparent and studied relate to lack of prescription drug usage. Of the approximately 187 million Americans who take one or more prescription drugs, up to one-half do not take their medications as prescribed. The end result of this failure is enormous, of the $290 billion mentioned above, over $100 billion is due to poor adherence to prescription drugs.

One of the tools with great potential is mobile and on-line technology. Patients have a chance to interact with health care information from the comfort of their home. Recent research by the Pew Resource Center found that 69% of individuals are already using their phone to track a variety of indicators such as weight, diet, routine, or symptoms. It is quite clear that individuals are becoming increasingly comfortable going on-line to obtain help in following their medication care plans.

While mobile technology helps to provide information that will begin to address the challenges of engagement and adherence, a much more traditional form of care is also a part of the picture, the family caregiver. Another recent study by Pew identified that 39% of U.S. adults are already providing some type of care for an adult or child with a significant health issue. Most of these individuals are in the 30 to 64 age group, which represents prime working years. The study also found that on-line resources have already become a significant tool for these family caregivers. Over 70% of these caregivers say that on-line resources are a primary source of information that is useful in their caregiving.

Accordingly, there is a need for a system to help or aid a patient to adhering to his/her care plan.

### SUMMARY OF THE INVENTION

Embodiments of the invention include a system for helping a patient adhere to a care plan, the care plan designed to be followed by the patient in order to improve the patient's health or protect the patient from undue harm, the system comprising: a task scheduling module configured to schedule one or more tasks included in the care plan, wherein a scheduled task is intended to be completed by the patient at the scheduled time; a task adherence estimation module configured to estimate the likelihood that the scheduled task will be completed by the patient at the scheduled time; and an alternative task presentation module configured to present the patient an alternative task, wherein the alternative task is intended to replace the scheduled task when the task adherence estimation module determines the patient is unlikely to complete the scheduled task and when the alternative task is accepted by the patient.

In an embodiment, the task adherence estimation module incorporates a weather prediction.

In an embodiment, the task adherence estimation module incorporates past history of the patient completing a similar task.

In an embodiment, the past history of the patient comprises the day of the week the task is scheduled.

In an embodiment, the past history of the patient comprises the time of day the task is scheduled.

In an embodiment, the scheduled task comprises exercise.

In an embodiment, the system further comprises a reminder module configured to alert the patient of an upcoming scheduled task.

In an embodiment, the system further comprises a task completion module configured to determine when a task has been completed by the patient.

In an embodiment, the task completion module incorporates the use of an electronic device on the patient to determine when the patient completes a task.

In an embodiment, the task completion module incorporates the use of an accelerometer or a GPS to determine when the patient completes the task.

In an embodiment, a system for helping a patient adhere to a care plan, the care plan designed to be followed by the patient in order to improve the patient's health, the system comprising: a task scheduling module configured to schedule one or more tasks included in the care plan, wherein a scheduled task is intended to be completed by the patient at the scheduled time; a task adherence reward module configured to provide a reward to a patient upon the patient completing a scheduled task; a reward calculation module configured to calculate the total amount of rewards provided to a patient; a patient comparison module configured to compare a plurality of patients to each other; and a comparison display module configured to display the results of the patient comparison module to a user.

In an embodiment, the plurality of patients are compared to each other with a normalized time period.

In an embodiment, the plurality of patients that are compared to each other are within a set age span, race, ethnic group, gender, geospatial proximity or other demographically unique grouping.

In an embodiment, the plurality of patients that are compared to each other share identically or statistically common secondary stored information.

In an embodiment, the common secondary stored information is past medical details such as medical observations or diagnoses.

In an embodiment, the common secondary stored information is historical records of educational or entertainment information consumed.

In an embodiment, the common secondary stored information is a record of advertisements viewed.

In an embodiment, the common secondary stored information is a record of common experiences such as places visited.

In an embodiment, the comparison display module is configured to anonymously display the results of the patient comparison module to the user.

In an embodiment, the patient selects one or more patients of the plurality of patients.

In an embodiment, a patient within the plurality of patients is able to communicate with another patient within the plurality of patients.

In an embodiment, a portion of the plurality of patients are not compared to the other patients in the patient comparison module.

In an embodiment, the portion of the plurality of patients that are not compared is a bottom portion of the plurality of patients.

In an embodiment, the bottom portion is the bottom 10% of patients.

In an embodiment, the plurality of patients are all adhering to a similar care plan, adhering to a care plan as recovery from the same procedure, or adhering to a care plan to avoid the same aliment.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The invention may be more completely understood in connection with the following drawings, in which:

FIG. 1 is a depiction of an environment in which the system could be used, according to an embodiment.

FIG. 2 is a schematic of steps in a system, according to an embodiment.

FIG. 3 is a schematic of steps in a likelihood to complete task process, according to an embodiment.

FIG. 4 is a schematic of a screenshot of a portion of the system, according to an embodiment.

FIG. 5 is a schematic of a screenshot of a portion of the system, according to an embodiment.

FIG. 6 is a depiction of an environment in which the system could be used, according to an embodiment.

FIG. 7 is a schematic of steps in a system, according to an embodiment.

FIG. 8 is a schematic of a screenshot of a portion of the system, according to an embodiment.

FIG. 9 is a schematic of a screenshot of a portion of the system, according to an embodiment.

FIG. 10 is a depiction of an example computing environment wherein one or more of the embodiments set forth herein may be implemented.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

In many scenarios a patient can be assigned a care plan. A patient can be assigned a care plan to help the patient recover from a medical procedure, such as a surgery. For example, the care plan can include taking prescription medications once a day and physical therapy once a week. A patient can be assigned a care plan to help improve the patient's overall health, such as to lose weight. For example, the care plan can include exercising a set number of times per week and follow up appointments with the doctor. A care plan can be at least partially designed by a healthcare provider, such as the patient's doctor.

A system to design or build a care plan that encourages a patient to optimize their care activities while minimizing unnecessary actions and disruptions to daily living is disclosed herein. The system can deliver tasks, communications, or rules through various electronic devices, such as mobile phones, web browsers (for e-mail and on-line messaging), a wearable pendant which can include visual and/or tactile alert devices and traditional telephone calls to communicate with the patient and members of the patients community to maximize the chance of a patient adhering to the care plan in a way that is enjoyable and effective.

The care plan can include a sequence of activities prescribed by a healthcare professional to a patient for the purpose of healing or rehabilitation. A care plan can include a series of tasks, such as activities (usually adherence to a prescribed course of action), community interactions, communications, goals, rewards, or responses to some measured state of health. The care plan can include a series of tasks to be attempted or accomplished over a period of time. The care plan can include a set of outcomes to be achieved at various points along the timeline. These outcomes can be measured by the patient, the health care provider, or automatically. The care plan can include a sequence of educational content that is consumed by the patient. The care plan can include a measure or measures of how well the patient adheres to the prescribed course of action.

A task included in a care plan can include any step or goal that helps the patient achieve the end goal of the care plan. The process of adapting a care plan for an individual patient can be automated. In an embodiment, each task can be codified, such as to allow the system to better understand each task. In an embodiment, a task can include a classification, a level, a duration, and a frequency. For example a task of walking for 30 minutes a day can be classified as an exercise at a moderate level for a duration of 30 minutes with a frequency of daily. The system can automatically codify each task in the care plan after it is entered by the healthcare professional.

Adherence to a care plan can include alignment between the patient's behaviors and the tasks included in the care plan. The closer the patient's behaviors align or match with the tasks included in the care plan, the better the patient is following or adhering to the care plan, and hopefully the patient will therefore have a higher likelihood of meeting the goal(s) of the care plan.

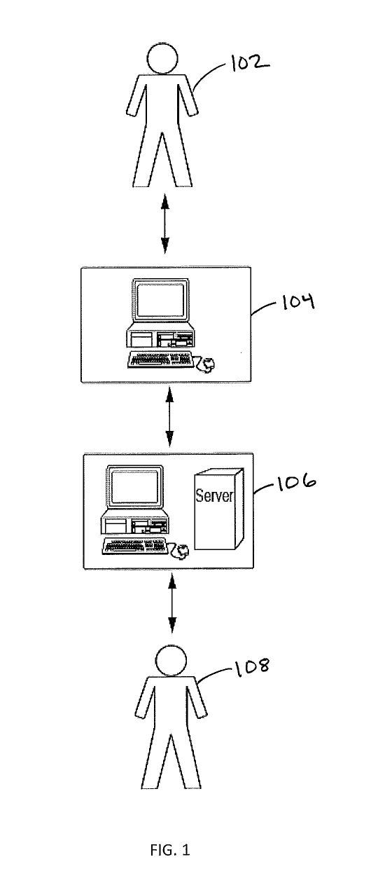

FIG. 1 is a depiction of an environment in which the system can be used, according to an embodiment. The system can include a patient 102. The patient 102 can be prescribed or assigned a care plan. The system can include one or more electronic devices 104, such as electronic devices 104 to relay information to the patient 102, to receive input that the patient 102 has completed a task, or to detect that the patient 102 has completed a task. The electronic device 104 can include a computer, a cell phone, or any other type of electronic device that is able to send or receive electronic communications. The electronic device 104 can communicate with a second electronic device 106, such as a server or an electronic device that can be accessed by a healthcare professional. The system can include a healthcare provider 108, such as a doctor. The healthcare professional 108 can be the person that assigned or prescribed the care plan to the patient 102.

The system can help a patient adhere to a care plan. The care plan can be designed to be followed by the patient in order to improve the patient's health. The system can include scheduling one or more tasks included in the care plan. The system can incorporate the patient's personal calendar to schedule tasks at times the patient is more likely to complete the tasks.

The system can organize and deliver rewards to the participants in the plan as well. These rewards will be dispensed in a way that will maximize the likelihood of someone adhering to the care plan. Rewards can be administered proportionately the importance of the particular activity that is considered necessary for the care plan completion.

The system can estimate or calculate the likelihood that the patient will complete a task at the scheduled time. The system can incorporate one or more of the following aspects into its calculation of the likelihood that the task will be completed: the predicted weather, the patient's calendar, historical information, care plan task codification, and alternative analysis aspects.

When the system's calculation or estimation falls below a threshold or predicts that it is unlikely that patient will complete the task, the system can provide an alternative task to the patient. The alternative task can be at a different time, a different activity, or a different time and a different activity. The patient can accept or deny the alternative task. If the alternative task is denied by the patient, a second alternative task can be provided to the patient. The process of offering different alternative tasks to the patient can be repeated until the patient accepts an alternative task or confirms the original task will be completed.

The system can negotiate with the patient, such as to potentially change tasks in the care plan. For example, if the care plan requires walking 30 minutes a day, the system can change walking to biking, such as if the patient is getting bored of walking The system can recognize walking is an exercise, and provide alternative exercise options to the patient, such as biking In an embodiment, a healthcare professional can have the ability to disable certain alternatives, such as if the healthcare professional does not want the patient doing a specific alternative. For example, a healthcare professional could disable biking for a patient that is recovering from orthopedic knee surgery (if the healthcare professional feels the patient should not be biking during the patient's recovery). The disablement can have a time period associated with it, such that the healthcare professional can disable an alternative for a period of time that is shorter than the total length of the care plan. For example, the healthcare professional might not want the patient biking for the first four weeks, but after four weeks the patient would be allowed to bike. In such an example, the healthcare professional can disable biking as an alternative for a time period of four weeks.

In an embodiment, the system can be authorized to negotiate a task down to less effort to complete. For example, the patient has a scheduling conflict on a Thursday evening and does not like the alternatives provided. The system can attempt to negotiate for a 15-minute walk instead that would not conflict with the patient's schedule. The patient would be presented with education on how any exercise is better than none and encouraged to do the lesser task for a day.

There are scenarios where the system is not authorized to suggest lesser tasks independent of the healthcare professional. In such situations, the system recognizing that it plans to make such offers can batch up the requests to the healthcare professional. The healthcare professional can review a list of patients and the proposed modifications and dates and simply flag/deny any that he/she is not comfortable with. Pattern matching allows the healthcare professional to answer the same for all requests in the list of particular types, if desired. Filters can be put on the healthcare professionals user interface that auto accepts certain change requests which can save the healthcare professional time. The doctor's short amount of time to review plans in a batch fashion like this can drastically increase the chances that his/her patients will remain adherent to the plans he/she has put in place for the patients.

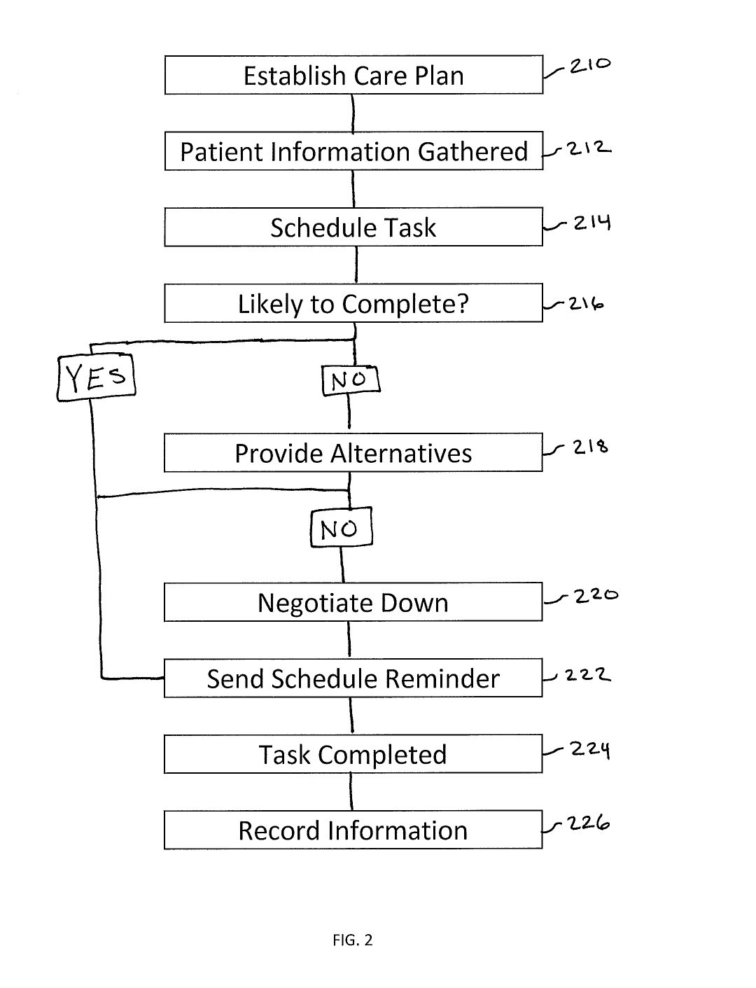

FIG. 2 is a schematic of steps in a system 200, according to an embodiment. In step 210, a care plan can be established for a patient. The care plan can be designed by a healthcare professional with the intention that the patient follows the care plan to improve the patient's health.

In step 212, information can be gathered about the patient, such as about the patient's lifestyle. The information can be gathered from the patient through an interview, a survey, a questionnaire or a similar information gathering technique. The information gathered can include a work schedule for the patient, such as to ensure a task is not scheduled at a time he/she is busy. The information gathered can include preferences of the patient, such as to increase the likelihood the patient will complete a task. For example, if the care plan requires that patient exercise, the system can determine what type of exercise the patient prefers. As part of the information gathering step, the system can also gather information about the patient's care team, such as family members, people that live with the patient, or people that the patient is dependent upon. In some cases, a care team member's ability to help the patient can be as influential on the patient's adherence to the care plan as the patient's actions.

In step 214, tasks can be scheduled. The tasks can be scheduled at days and times that are the most convenient for the patient, such as to increase the likelihood that the patient will complete that task, thereby adhering to the care plan.

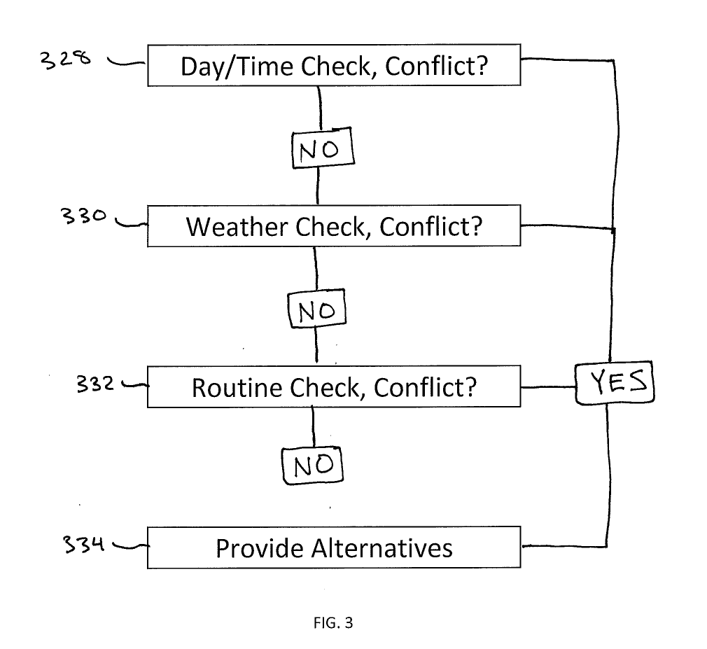

In step 216, as discussed below in reference to FIG. 3, a task can be evaluated for the likelihood it will be completed by the patient at the scheduled time. If the likelihood of the patient completing the task is below a threshold, an alternative task can be provided to the patient in step 218. If the patient does not accept the alternative task, a second alternative task can be provided to the patient. If the patient fails to accept any of the provided alternative tasks, the system can provide a lesser or negotiated down task, such as 20 minutes of exercise instead of 30 minutes of exercise, step 220.

If the patient accepts an alternative task, a negotiated down task, or the system calculated the likelihood of the original task being completed was above the threshold, a reminder can be sent to the patient in step 222. The reminder can be an electronic message to the patient, such as a text message or an email. The reminder can provide information to the patient of an upcoming task, such as to ensure the patient is aware of the task and is prepared for the task. The task can be completed by the patient in step 224.

Once the task is completed or the timeframe to complete the task has passed, information can be recorded about the task, in step 226. The information can be recorded to improve the calculation of the likelihood to complete a task in the future. If the task was successfully completed the circumstances around the task will be viewed favorably in the future. For example, if the task was to walk for 30 minutes after work at 5:00 pm on a Wednesday, the next time the patient is scheduled to walk for 30 minutes at 5:00 pm on a Wednesday the estimation will view those circumstances as favorable. However, if the scheduled task was not completed, the circumstances around the task will be viewed unfavorably in the future. How the circumstances around the resolution of a task are viewed can factor into the ordering of future choices as alternatives to be offered to the patient. Patients that accept 5:00 pm walks as alternatives but only completely 50% of them will have other alternatives that have had higher success rates presented first when an alternative is needed.

In an embodiment, the system can automatically detected the task was completed. For example, if the task was to walk for 30 minutes, an electronic device on the patient, such as a GPS can track how long the patient is walking for and upload the information to the system.

FIG. 3 is a schematic of steps in the system's calculation of the likelihood a patient will complete a given task 300, according to an embodiment. In an embodiment, the calculation of the likelihood a patient will complete a given task can include an evaluation of the day and time, step 328. For example, if the patient has a meeting at 5:00 pm on a Wednesday, it is unlikely the patient will be able to complete his/her exercise at 5:00 pm on Wednesday. Alternatively, if the task is to take a prescription medication, the overlap with a meeting might not be a conflict, such as if the patient can take the medication prior to the meeting starting or possibly during the meeting.

In an embodiment, the calculation of the likelihood a patient will complete a given task can include an evaluation of the predicted weather, step 330. For example, if the patient is scheduled to exercise outside in the morning, but the weather forecast calls for rain at the scheduled time, it might be unlikely the patient exercises, because of the rain. The system could recommend exercising indoors or at a different time when it is predicted to be pleasant outside, such as in step 334. The simple act of helping the patient think ahead to the needs of a task can increase their likelihood of adherence. If the system reminds the person of their planned 5:00 pm walk and the weather, the patient might decide he/she does not need an alternative task. Rather by being reminded in the morning, he/she can take an umbrella and raincoat so that he/she is prepared for the weather contingency.

In an embodiment, the calculation of the likelihood a patient will complete a given task can include an evaluation of the patient's routine, step 332, such as if the patient has failed to complete the task under similar circumstances, such as the patient has previously, or frequently not exercised after work or has failed to take medication in the morning. Step 334 can include providing alternative tasks to the patient when there is a conflict or the system has determined it is unlikely the patient will complete the task at the scheduled time.

In some embodiments, the likelihood of completion calculation 300 can include historical information of other patients or care plan task codification (such as the history of the patient with tasks in a similar classification).

The combination of actual tasks done and the patient's interactions with the system (the patient's intentions as observations) provide a very rich set of valuable data. This data can be used in making more intelligent suggestions to the patient over time. Unpopular options can be excluded from alternatives provided to the patient.

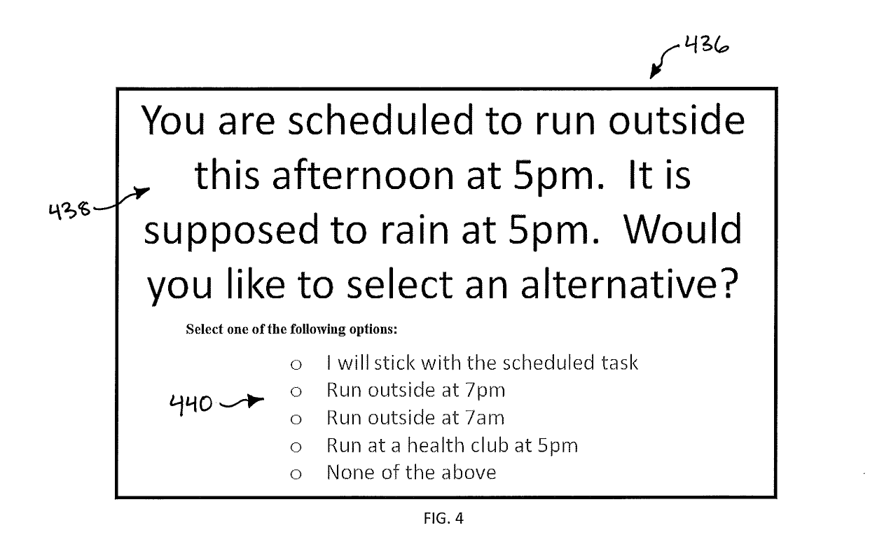

FIG. 4 is a schematic of a screenshot 436 of a portion of the system from the patient's electronic device, according to an embodiment. The patient can be notified of the scheduled task and the possible issue with the task, shown generally at 438. The patient can be provided with one or more options 440. Shown in FIG. 4 are alternative times or locations to complete the same task. In an embodiment, only a single alternative is provided to the patient at a time, such as to encourage a patient to select an alternative that is most similar to the scheduled task or that is mostly likely to be completed by the patient, thereby more closely adhering to the care plan.

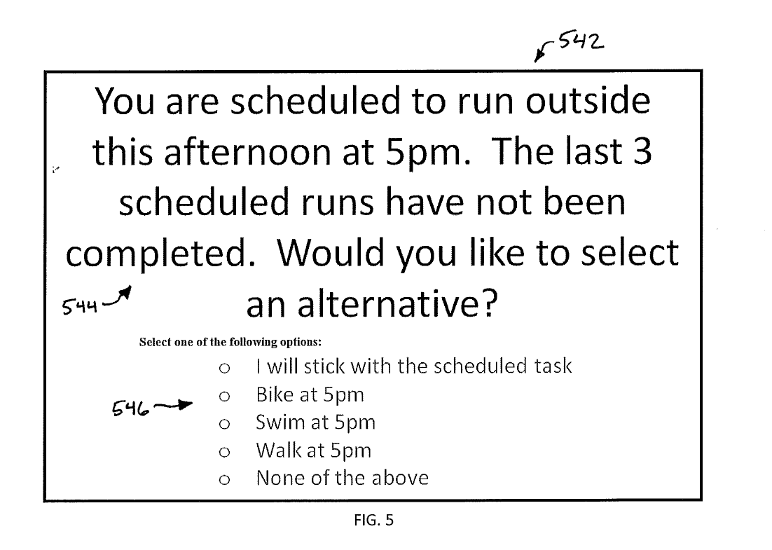

FIG. 5 is a schematic of a screenshot 542 of a portion of the system from the patient's electronic device, according to an embodiment. The patient can be notified of the scheduled task and the possible issue(s) with the task, shown generally at 544. Shown in FIG. 5 are alternative tasks within the same category as the scheduled task. The patient can be provided with one or more options 546 as alternative tasks. In an embodiment, only a single alternative is provided to the patient at a time, such as to encourage a patient to select an alternative that is most similar to the scheduled task or that is mostly likely to be completed by the patient, thereby more closely adhering to the care plan.

In many scenarios a patient can require or want help from other people in adhering to his/her care plan. Further, in various embodiments, a patient's care plan can include a social care plan, such as a plan to encourage social interaction for the patient. A care team can be set up to help the patient adhere to his/her care plan and social care plan.

The care team can include one or more people that are able to help the patient adhere to his/her care plan. The care team can include relatives, friends, and healthcare professionals. The care team can help the patient adhere to the care plan, such as by providing transportation, social interaction, encouragement, support and reminders. For example, after a medical procedure, such as a surgery, the patient may be unable to drive for an extended period of time. During such a period of time the patient will need help from others, such as a care team member.

In various embodiments, each member of the care team can have a support plan. The support plan can include steps that the member of the care team is intended to accomplish in order to help the patient adhere to his/her care plan. The support plan can be unique for each member of the care team, such that each member's support plan is directed at the member's role.

Each care team member can have a defined role on the care team. A member's role can be determined by the member's set of attributes and responsibilities that he/she can carry out as part of the care plan. The support plan for a care team member can be greatly influenced by the role the member has on the care team. For example, a member's role can be to transport the patient to and from appointments as needed. That member's support plan would include the schedule of appointments that he/she is responsible for transporting the patient to and from. Further, a second team member might not be able to drive the patient, but the patient might be quite comfortable with talking to the second team member. The second team member's role can be to provide social interaction, encouragement and emotional support to the patient. The second team member's support plan can include tasks such as calling the patient to discuss symptoms or upcoming tasks on the patient's care plan.

The support plans for different care team members can be flexible or fluid, such that the support plans are able to change or adapt to different circumstances as needed. The support plans can be fluid, such that the support plans can add a task if a new task is needed or delete a task if a task is no longer needed. A task can also move from one member's support plan to a second member's support plan. If a member of the care team is unable to fulfill a step on his/her support plan, a different team member can be asked to fulfill the step, such as to ensure the patient is adhering to the care plan.

In various embodiments, the care plan can include a social care plan. The care team can help the patient fulfill his/her social care plan, such as by providing the patient with social interaction.

In another example, a patient might need social interaction, such as if the patient lives alone. One or more care team members can be designated to provide social interaction with the patient, such as daily human interaction, necessary reminders, and encouragement to adhere to the care plan.

As discussed above, the care team can have responsibility to help the patient adhere to the care plan when the patient cannot physically do so on his/her own, such as when the patient is unable to drive to a doctor's appointment. Additionally, the care team can have other responsibilities, such as to encourage or motivate the patient to adhere to the care team. The care team can further provide the patient with social interaction. In various embodiments, one or more care team member can be responsible for ensuring the patient has social interaction. The care plan can include how often (frequency) the patient should have social interaction and how long (duration) the social interaction should last. Support plans can include how often the specified care team member should interact with the patient and for how long the interaction should last. The care plan can include a schedule of social interaction, such as which days and at what time social interaction should take place. The care plan can specify what type of social interaction the patient should have; for example, face to face, phone call, or video conference.

In various embodiments, the content of the social interaction can be evaluated. For example, patient inquiries about certain symptoms or topics can lead to additional conditions or symptoms of the patient being revealed. In various embodiments, the content of the social interaction can be evaluated by speech analytics, such as to recognize any changing patterns in the patient's communications. In some embodiments, a slowdown in social velocity might indicate the patient is not adhering to the care plan and can trigger review of the care plan, review of the patient's adherence to the care plan, or a review of the care team's members or support.

### Gamification Techniques

Various gamification techniques can be used to encourage patients to remain adherent to the care plan. These techniques can include but are not limited to concepts such as earning rewards/badges/points or ranking users on leader boards (either against people they have “friended” with similar care plan tasks or anonymously against people on similar plans).

These gamification techniques are augmented by the concepts described above. For example, successfully planning around a scheduling conflict and making a different exercise time work for a day can earn leaderboard points or badges specific to the hurdle that has been overcome.

Further, the comparisons can have the time normalized, such that the patient can be compared to other patients that have previously completed a similar care plan. For example, the patient can be compared after 1 week to other patients after 1 week, even though other patients might have started their care plans weeks, months, or years prior.

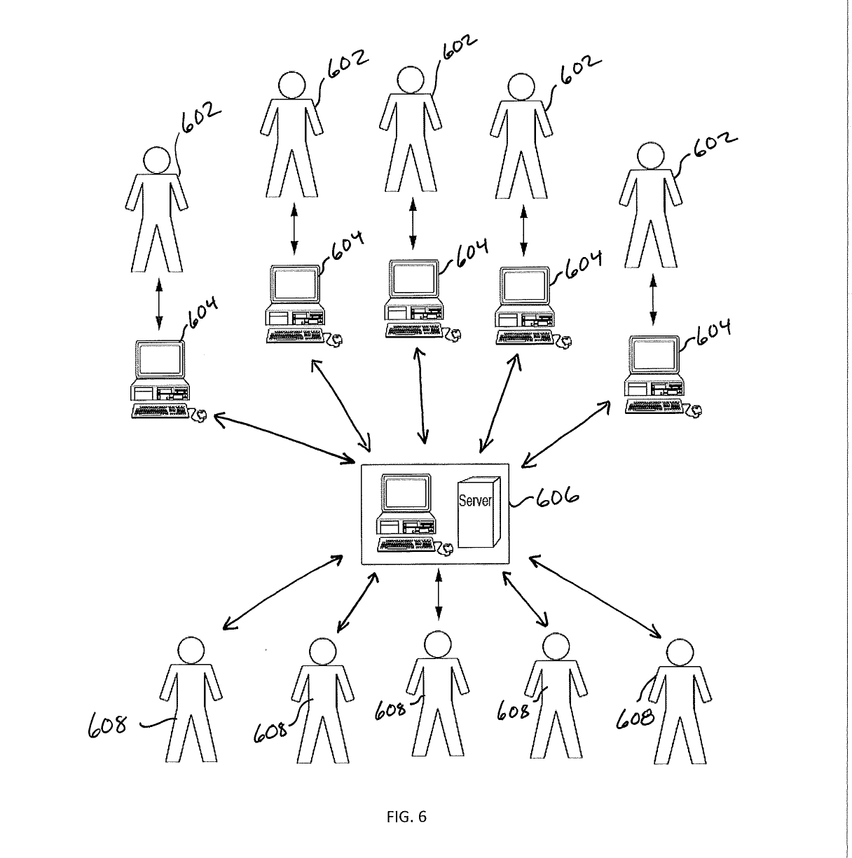

FIG. 6 is a depiction of an environment in which the system could be used, according to an embodiment. The system can include multiple patients 602. The patients 602 can be prescribed or assigned similar care plans or different care plans. The system can include one or more electronic devices 604, such as at least one electronic device 604 for each patient. The electronic devices can relay information to the patients 602, receive input that a patient 602 has completed a task, or to detect that the patient 102 has completed a task. The electronic device 604 can include a computer, a cell phone, or any other type of electronic device that is able to send or receive electronic communications. The electronic device 604 can communicate with a second electronic device 606, such as a server or an electronic device that can be accessed by a healthcare professional. The system can include a healthcare professional 608, such as a healthcare professional 608 for each patient 602. The healthcare professional 108 can be the person that assigned or prescribed the care plan to the patient 602.

The system for helping patients adhere to a care plan can include rewarding a patient for completing a task. A patient's rewards can be accumulated and compared to other patients, such as other patients with a similar care plan. The patients can be compared such as to encourage the patients to try and outperform each other by being the closest to adhering to his/her care plan. The comparison can be displayed to the patients, such that each patient is aware of how he/she compares to other similarly situated patients.

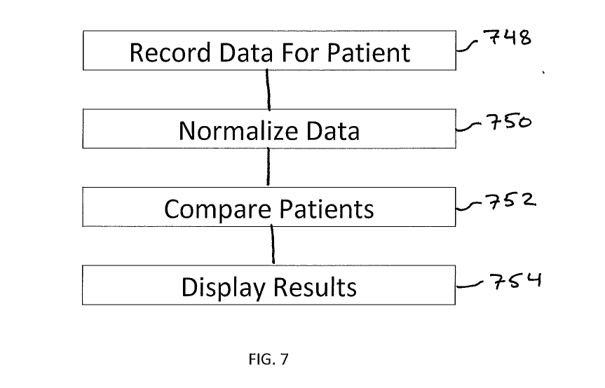

FIG. 7 is a schematic of steps to compare multiple patients to each other, according to an embodiment. In step 748, the system can record data from a patient, such as if the patient completed a task and the reward for the completion of the task. The rewards can be compiled in the recording of data, such that a new reward is added to the previously earned rewards. In step 750, the system can normalize the amount of rewards for the amount of time the patient has been following the care plan, such that the comparison between patients is an accurate reflection of how well each patient is adhering to his/her care plan compared to the other patients at a common point in time associated with the care plan.

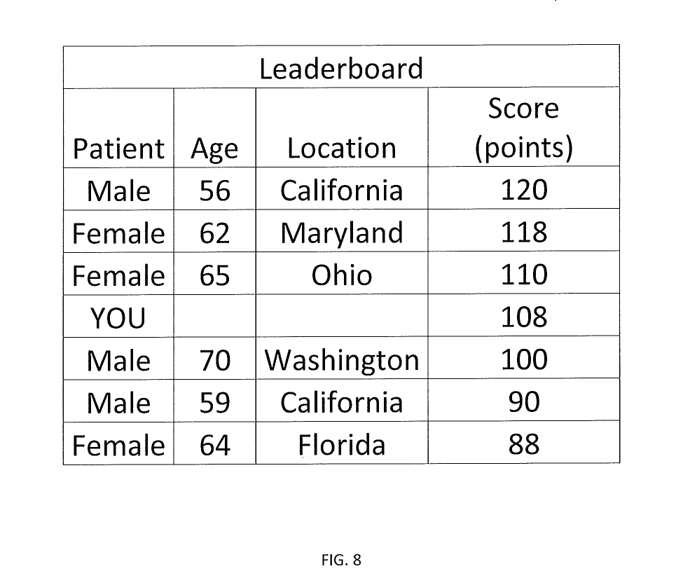

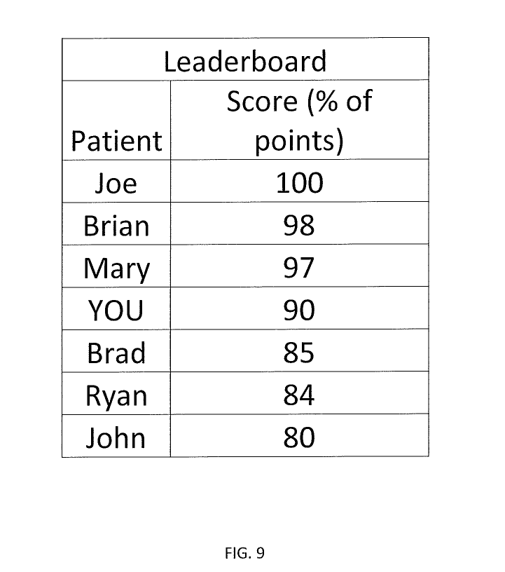

In step 752, the patients can be compared to each other. The patients can be sorted from the most amount of rewards (points, highest adherence rate) to the lowest amount of rewards. In step 754, the results of the comparison can be displayed to a patient (examples are shown in FIG. 8 and FIG. 9). In an embodiment, similar patients can be compared to each other. Patients can be grouped or compared to each other based on characteristics such as gender, age, ethnicity, race, religious indication, geographic location, care plan prescribing doctor, hospital or institution the patient is associated with.

In an embodiment, the plurality of patients that are compared to each other can share identically or statistically common secondary stored information, characteristics, or attributes. In an embodiment, the common secondary stored information can include past medical details such as medical observations or diagnoses. In an embodiment, the common secondary stored information can include historical records of educational or entertainment information consumed, such as by the patient. In an embodiment, the common secondary stored information is a record of advertisements viewed. In an embodiment, the common secondary stored information can include a record of common experiences such as places visited. It should be further understood additional or alternative characteristics can also be used.

The patients that are compared to each other can be anonymous, such as to comply with HIPAA rules and regulations (as shown in FIG. 8). The patients can be compared to other patients that have had or currently have similar care plans. In an embodiment, the population of patients that are compared can include patients that are all adhering to a similar care plan, adhering to a care plan as recovery from the same procedure, or adhering to a care plan to avoid the same aliment. In an embodiment, there can be a communication element between the patients, where patients can communicate to each other, such as to offer encouragement or ask each other questions. In an embodiment, the communications can be anonymous.

In an embodiment, the patient is compared to a population of patients that have had a similar care plan. In an embodiment, the bottom portion of the patients that have had similar care plans are not shown or compared to the patient, such that the patient is only compared to a top portion of patients adhering to their care plans, such as to increase the motivation of the patient or to make the patient believe he/she is not adhering to the care plan as well as the average patient. In an embodiment, the bottom portion of the patient population that is removed is 10%, 15%, 20%, 25% or 50%.

Patients can also select or “friend” other patients to be compared to. For example, if a person knows a friend or a family member currently has a care plan, they could compete to see who can adhere to their plan the best. In some cases a percentage of total rewards or points possible can be used to normalize patients with different care plans.

FIG. 8 is a schematic of a screenshot of a portion of the system, according to an embodiment. As shown in FIG. 8, the patients can be compared anonymously. The patients can be ranked in order of the rewards earned by each patient. In an embodiment, a patient can earn a reward for each task that he/she completes. For example, a patient can earn 10 points for completing a task of exercising for 30 minutes, or 8 points for a negotiated down task of exercising for 20 minutes. Patients can also earn rewards for gritting it out, such as if there are multiple conflicts or the system calculates it is unlikely the patient will complete the task, but a patient still completes the task.

FIG. 9 is a schematic of a screenshot of a portion of the system, according to an embodiment. FIG. 9 shows a comparison among people that have been selected by each other. In such a scenario, a patient can allow other patients to see additional information about himself/herself, such as his/her name. FIG. 9 also shows patients being compared based on a percentage, such as points earned out of possible points earned at that point in time. Comparing patients based on percentages can allow patients of different care plans to be compared.

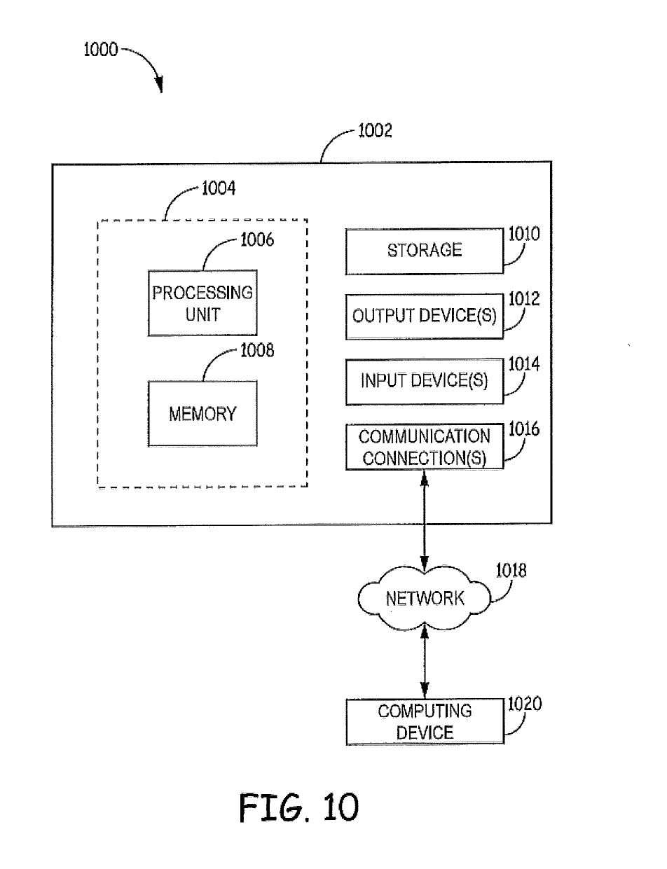

FIG. 10 shows an example of a computing device 1002 within the system 210, which can be used to carry out the embodiments described herein. Example computing devices include, but are not limited to, personal computers, server computers, hand-held or laptop devices, tablet computers, mobile devices, mobile phones, Personal Digital Assistants (PDAs), media players, multiprocessor systems, consumer electronics, mini computers, mainframe computers, and distributed computing environments that include any of the above systems or devices.

In one configuration, the computing device 1002 includes at least one processor 1006 and at least one memory component 1008. Depending on the exact configuration and type of computing device, the memory component 1008 may be volatile (such as RAM, for example), non-volatile (such as ROM, flash memory, etc., for example) or an intermediate or hybrid type of memory component. This combination of the processing unit 1006 and the memory unit 1008 is illustrated in FIG. 10 by dashed line 1004.

In some embodiments, device 1002 may include additional features, additional functionality or both. For example, device 1002 may include one or more additional storage components 1010, including, but not limited to, a hard disk drive, a solid-state storage device, and/or other removable or non-removable magnetic or optical media. In one embodiment, the storage component 1010 comprises non-transitory computer readable storage medium. In one embodiment, computer-readable and processor-executable instructions implementing one or more embodiments provided herein are stored in the storage component 1010. The storage component 1010 may also store other data objects, such as components of an operating system, executable binaries comprising one or more applications, programming libraries (e.g., application programming interfaces (APIs), media objects, and documentation. The computer-readable instructions may be loaded in the memory component 1008 for execution by the processor 1006.

The computing device 1002 may also include one or more communication components 1016 that allows the computing device 1002 to communicate with other devices. The one or more communication components 1016 may comprise (e.g.) a modem, a Network Interface Card (NIC), a radiofrequency transmitter/receiver, an infrared port, and a universal serial bus (USB) USB connection. Such communication components 1016 may comprise a wired connection (connecting to a network through a physical cord, cable, or wire) or a wireless connection (communicating wirelessly with a networking device, such as through visible light, infrared, or one or more radiofrequencies.

The computing device 1002 may include one or more input components 1014, such as keyboard, mouse, pen, voice input device, touch input device, infrared cameras, or video input devices, and/or one or more output components 1012, such as one or more displays, speakers, and printers. The input components 1014 and/or output components 1012 may be connected to the computing device 1002 via a wired connection, a wireless connection, or any combination thereof. In one embodiment, an input component 1014 or an output component 1012 from another computing device may be used as input components 1014 and/or output components 1012 for the computing device 1002.

The components of the computing device 1002 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of the computing device 1002 may be interconnected by a network. For example, the memory component 1008 may be comprised of multiple physical memory units located in different physical locations interconnected by a network.

Those skilled in the art will realize that storage devices utilized to store computer readable instructions may be distributed across a network. For example, a computing device 1020 accessible via a network 1018 may store computer readable instructions to implement one or more embodiments provided herein. The computing device 1002 may access the computing device 1020 and download a part or all of the computer readable instructions for execution. Alternatively, the computing device 1002 may download pieces of the computer readable instructions, as needed, or some instructions may be executed at the computing device 1002 and some at computing device 1020.

An exemplary computer-readable medium (e.g., a CD-R, DVD-R, or a platter of a hard disk drive) may be encoded with computer-readable data. This computer-readable data in turn comprises a set of computer instructions that, when executed by the processor 1006 of the computer device 1002, cause the computer device to operate according to the embodiments presented herein. In one such embodiment, the processor-executable instructions may be configured to cause the computer device to perform a method of evaluating a patient. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The processor can include a task scheduling module configured to schedule a task included in the patient's care plan. The task is intended to be completed at the scheduled time. The scheduled time can include one or more of a year, month, day, and a specific time. The scheduled task can include a date, such as if a patient is supposed to complete a certain task on a certain day. The scheduled task can include a specific time and a specific date, such as it the patient is supposed to complete the task on a certain day at a certain time.

The processor can include a task adherence estimation module configured to estimate the likelihood that a task will be complete by the patient at the scheduled time. The task adherence estimation module can incorporate one or more of the following aspects into its calculation of the likelihood that the task will be completed: the predicted weather, the patient's calendar, historical information, care plan task codification, and alternative analysis aspects.

The processor can include an alternative task presentation module configured to present the patient with an alternative task, when the task adherence estimation module estimates the likelihood of the scheduled task being complete is unlikely or below a certain threshold. The alternative task can replace the task that was scheduled. The alternative task can include a task at a different date and/or time to be completed, a different task within the same category (such as biking instead of jogging), or a task for a different date and/or time and a different task within the same category. The alternative task presentation module can present the patient with an alternative task and the patient can accept or deny the alternative task. If the patient accepts the alternative task, the alternative task can replace the previously scheduled task. If the patient denies the alternative task, the patient can be presented with a second alternative task. The process of presenting the patient with alternative tasks can be repeated until the patient accepts an alternative. In an embodiment, two or more alternative tasks can be presented to the patient, such as simultaneously presented. In an embodiment, each subsequent alternative that is presented to the patient can be further away from the designed care plan. For example, if the care plan included 30 minutes of exercise, the first alternative task could be 30 minutes of exercise at a different time, a second alternative task could be 25 minutes of exercise, a third alternative task could be 20 minutes of exercise, and a fourth alternative could be adjusting a future scheduled 30 minutes of exercise to 45 minutes of exercise.

The processor can include a reminder module configured to alert the patient of an upcoming scheduled task. The reminder module can send an alert or a notification of an upcoming task that is scheduled. In an embodiment, the reminder module can send a single notification for all of the upcoming tasks within a time period. The time period can be one day, two days, one week, two weeks, one month, or two months. It should be understood that other time periods are also possible. In an embodiment, the reminder module can send an alert at or near the scheduled time, such as at the scheduled time, five minutes prior to the scheduled time, or 30 minutes prior to the scheduled time. In an embodiment, the reminder module can send an individual notification for each upcoming scheduled task. In an embodiment, two or more notifications can be send for scheduled task, such as a notification one week before the scheduled task, one day before the scheduled task, and at the time of the scheduled task.

The processor can include a task completion module configured to determine or detect when a task has been completed by the patient. In an embodiment, the task completion module can include a manual entry, such as a patient informing the system that the task has been completed. In an embodiment, the task completion module can include an automatic entry, such that the system can sense or detect the task was completed. The task complete module can incorporate the used of an electronic device, such as an electronic device on the patient, to determine if/when the task is completed. In an embodiment, the electronic device can include an accelerometer or a GPS system. Alternative automatic entry systems are also available depending on the category of task. For example, if the task includes taking prescription medical, the automatic entry system can include an entry when the patient refills his/her prescription.

The processor can include a reward calculation module configured to determine when the patient has completed a task, provide the patient with a reward, and calculate the total amount of rewards the patient has earned. The patient can earn points or rewards to determine how well he/she is adhering to his/her care plan.

The processor can include a patient comparison module configured to compare a plurality of patients to each other. Patients can be grouped and compared to each other, such as by how many rewards the patients have earned. In an embodiment, a patient can be compared to similar patients, such as patients of similar age, gender, reason for care plan, or location. In an embodiment, a patient can be compared to a general population of other patients with care plans. In an embodiment, a portion of the general population can be removed from the comparison, such as a bottom portion. The bottom portion can be those patients that are the farthest from following their care plans.

The processor can include a comparison display module configured to display the results of the patient comparison module to a user or the patient. The results of the patient comparison module can be displayed on a user interface, such as a computer screen or a similar electronic screen. The results can be displayed in a leaderboard type manner, such as patients being ordered from worst at following their care plan to best at following their care plan, such as where the patients that are most closely following their care plans are listed at the top and the patients that are failing to follow their care are listed at the bottom.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

The claims are:

1. A system for helping a patient adhere to a care plan, the care plan designed to be followed by the patient in order to improve the patient's health or protect the patient from undue harm, the system comprising:
a task scheduling module configured to schedule one or more tasks included in the care plan, wherein a scheduled task is intended to be completed by the patient at the scheduled time;
a task adherence estimation module configured to estimate the likelihood that the scheduled task will be completed by the patient at the scheduled time; and
an alternative task presentation module configured to present the patient an alternative task, wherein the alternative task is intended to replace the scheduled task when the task adherence estimation module determines the patient is unlikely to complete the scheduled task and when the alternative task is accepted by the patient.

2. The system of claim 1, wherein the task adherence estimation module incorporates a weather prediction.

3. The system of claim 1, wherein the task adherence estimation module incorporates past history of the patient completing a similar task.

4. The system of claim 3, wherein the past history of the patient comprises the day of the week the task is scheduled.

5. The system of claim 1, wherein the past history of the patient comprises the time of day the task is scheduled.

6. The system of claim 1, wherein the scheduled task comprises exercise.

7. The system of claim 1, further comprising:
a reminder module configured to alert the patient of an upcoming scheduled task.

8. The system of claim 1, further comprising:
a task completion module configured to determine when a task has been completed by the patient.

9. The system of claim 8, wherein the task completion module incorporates the use of an electronic device on the patient to determine when the patient completes a task.

10. The system of claim 8, wherein the task completion module incorporates the use of an electronic device on the patient to determine when the patient completes the task.

11. The system of claim 10, wherein the electronic device comprises an accelerometer or a GPS.

12. A system for helping a patient adhere to a care plan, the care plan designed to be followed by the patient in order to improve the patient's health, the system comprising:
a task scheduling module configured to schedule one or more tasks included in the care plan, wherein a scheduled task is intended to be completed by the patient at the scheduled time;
a task adherence reward module configured to provide a reward to a patient upon the patient completing a scheduled task;
a reward calculation module configured to calculate the total amount of rewards provided to a patient;
a patient comparison module configured to compare a plurality of patients to each other; and
a comparison display module configured to display the results of the patient comparison module to a user.

13. The system of claim 12, wherein the plurality of patients are compared to each other with a normalized time period.

14. The system of claim 12, wherein the plurality of patients that are compared to each other are within a set age span.

15. The system of claim 12, wherein the comparison display module is configured to anonymously display the results of the patient comparison module to the user.

16. The system of claim 12, wherein the patient selects one or more patients of the plurality of patients.

17. The system of claim 12, wherein a patient within the plurality of patients is able to communicate with another patient within the plurality of patient.

18. The system of claim 12, wherein a portion of the plurality of patients are not compared to the other patients in the patient comparison module.

19. The system of claim 18, wherein the portion of the plurality of patients that are not compared is a bottom portion of the plurality of patients.

20. The system of claim 19, wherein the bottom portion is the bottom 10% of patients.
